(19) United States
(12) Patent Application Publication
(10) Pub. No.: US 2025/0368292 A1
(43) Pub. Date: Dec. 4, 2025

(54) ARM AND LEG POWERED APPARATUS

(71) Applicant: Mark W. Kirchner, Seattle, WA (US)

(72) Inventor: Sam William Kirchner, Seattle, WA (US)

(21) Appl. No.: 19/224,384

(22) Filed: May 30, 2025

Related U.S. Application Data
(60) Provisional application No. 63/655,518, filed on Jun. 3, 2024.

(51) Int. Cl. B62M 1/12; B62K 9/02; B62K 21/00; B62K 21/12; B62K 21/18; B62K 23/06; B62M 1/24; B62M 1/36

(52) U.S. Cl. CPC B62M 1/12; B62K 21/00; B62K 21/12; B62K 21/18; B62K 23/06; B62M 1/24; B62M 1/36; B62K 9/02

(57) ABSTRACT

Embodiments of the present disclosure include an apparatus powered by arms and legs with the legs transmitting power through foot pedals coupled to pedal arms that are coupled to a shaft offset of the pedal sprocket center shaft. Arms transmit power through a lever arm system with pivot points coupled to the frame to isolate arm power motion from front fork steering motion. Steering levers mounted on arm cranks control motion to the steering column and front wheel forks through a cable.

### CROSS REFERENCE TO RELATED APPLICATIONS

This application claims priority to U.S. Provisional Patent Application No. 63/655,518, filed Jun. 3, 2024.

### BACKGROUND

The present disclosure relates generally to human powered systems, and in particular, to techniques for powering a mobile apparatus using arms and legs.

Human powered systems are used for a variety of purposes. For example, a bicycle is an example of a human powered mobile system. People use bicycles for both recreational and non-recreational use. Human powered mobile systems are preferrable to machine powered systems for a variety of reasons. In some cases, people prefer human powered mobile systems for physical and health benefits. Typical bicycles offer users the opportunity to exercise leg muscles, for example. However, some people consider bicycle riding as less desirable than other forms of exercise (e.g., swimming) because there is limited opportunity to exercise the arms. Additionally, when people do go for a bike ride, it is often desirable to increase the speed (e.g., relative to other uses or relative to the time it would take to get to a destination using a car).

Existing arm and leg powered systems have a variety of shortcomings. For example, it is a challenge to provide robust steering in the arm portion of such propulsion systems. Furthermore, it can be challenging to optimize arm and leg power transfer while maintaining steering control and stability. Additionally, it is challenging to make an arm and leg powered systems ergonomically practical.

The following disclosure provides various solutions to overcome issues related to arm and leg powered systems.

### BRIEF DESCRIPTION OF THE DRAWINGS

FIG. 1 illustrates an example arm and leg powered apparatus according to an embodiment.

FIG. 2 illustrates coupling power from an arm to a crank post according to an embodiment.

FIG. 3 illustrates an example steering mechanism according to an embodiment.

FIG. 4 illustrates an example steering mechanism according to an embodiment.

FIG. 5A illustrates another example steering mechanism according to an embodiment.

FIG. 5B illustrates another example steering mechanism according to an embodiment.

FIG. 5C illustrates another example steering mechanism according to an embodiment.

FIG. 6A illustrates another example of a mechanical arm according to an embodiment.

FIG. 6B illustrates another view of the example mechanical arm according to an embodiment.

### DETAILED DESCRIPTION

Described herein are techniques for arm and leg powered systems. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Embodiments of the present disclosure include arm and leg powered apparatus. In the following description, various aspects and advantages of various embodiments are described in the context of an example bicycle. However, one of ordinary skill in the art will understand that the features and advantages of various aspects of the disclosure may be implemented in other types of systems. Accordingly, the present disclosure is not limited to bicycles.

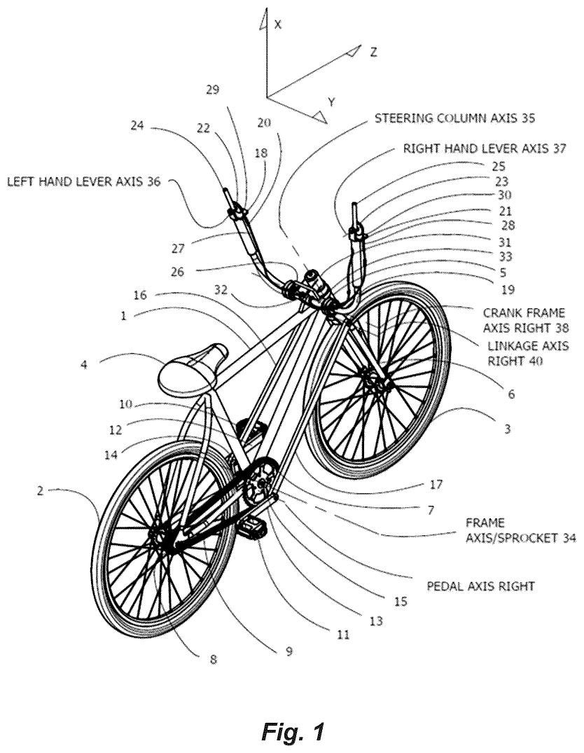

FIG. 1 illustrates an example arm and leg powered apparatus according to an embodiment. In this example, the arm and leg powered apparatus is a bicycle 100. Bicycle 100 includes a frame 1 coupled to a rear wheel 2 and front wheel 3. First, the front wheel is configured to steer the bicycle 100 as described herein. Features and advantages of the present disclosure include a mechanism for using arms and legs to power the bicycle 100. A user may engage a first steering lever 24 configured on a first side of the frame (e.g., the left side) and a second steering lever 25 configured on a second side of the frame (e.g., the right side). Power from the human arms of a user is coupled to the rear wheel through first and second mechanical arms. For example, a first arm is coupled between the first steering lever 24 and a first crank post 32 (e.g., a left crank post) through a first pivot point 39 on the first side of frame 1. A second arm is coupled between the second steering lever 25 and a second crank post 33 through a second pivot point 40 on a second side of the frame 1. Each arm, pivot point, and crank post are an example means for arm power transfer.

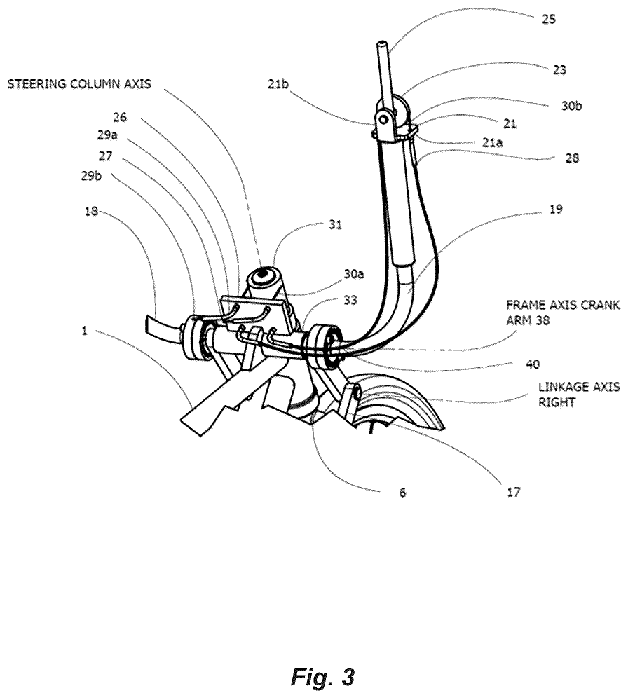

In this example embodiment, the first arm comprises a first arm member 18 (e.g., from the left steering lever) and a second arm member 16 (e.g., from the left crank post). The first and second arm members are rotationally coupled together (aka, linked) along a linkage axis, which may be orthogonal to a plane formed by the frame, for example. Similarly, the second arm comprises a third arm member 19 (e.g., from the right steering lever) and a fourth arm member 17 (e.g., from the right crank post). The third and fourth arm members are rotationally coupled together (aka, linked) along a linkage axis, which may be orthogonal to a plane formed by the frame, for example. Example arm members are described further in FIG. 3 below. Briefly, in various embodiments, one of the first arm member or the second arm member may be coupled to the first side of the frame (e.g., at a frame crank post described further below) and the other one of the first arm member or the second arm member may be coupled to the first crank post. Further, one of the third arm member or the fourth arm member is coupled to the second side of the frame (e.g., at another frame crank post described further below) and the other one of the third arm member or the fourth arm member may be coupled to the second crank post. Accordingly, in this embodiment, when a user applies a first force on the first steering lever in a direction parallel to the frame and a second force on the second steering lever in a direction parallel to the frame, power from the steering levers is translated to the crank posts to drive the rear wheel. It is to be understood that a variety of other mechanisms may be used to coupled power from the steering levers to the crank post through an arm coupled to pivot points on the frame.

Bicycle 100 further includes a first pedal 10 coupled to the first crank post 14 on the first side of the frame and a second pedal 11 coupled to the second crank post 15 on the second side of the frame. A user may place their feet on the pedals and drive the first and second crank posts using power from the legs, which may combine with power coupled from the arms to drive the crank posts and rear wheel via a chain 9, for example.

Features and advantages of the present disclosure may allow movement of the first and/or second steering levers to rotate the steering column independently of movement of the first and second steering levers to move the first and second crank posts. Delivering power from the arms and steering at the same time can disrupt the control and/or balance that must be maintained during movement. Accordingly, by decoupling arm power delivery to the crank posts from steering, the design advantageously improves the stability of an apparatus. For example, a steering column 5 is configured to be movably coupled to the frame and rigidly coupled to the first wheel. Accordingly, steering column 5 is one example means for moving the first wheel relative to the frame. In this example, a front wheel 3 may be bolted between front forks 6, while steering column 5 may be rotationally coupled to the frame to move the wheel left and right. In various embodiments, a first cable is coupled between the left steering lever 24 and the steering column, and a second cable coupled is coupled between the right steering lever 25 and the steering column. As mentioned above, steering levers 24 and 25 are configured to move in a plane parallel to the frame, where movement of the first and second steering levers in this plane moves the first and second crank posts and drives the rear wheel. Additionally, steering levers 24 and 25 are configured to move in another plane, where movement of the levers in the other plane rotates the steering column and the front wheel (e.g., left and right). In some embodiments, an angle of the steering levers in the plane of the frame may be adjusted as illustrated in an example below. While two (2) steering levers are illustrated in the present example, it is to be understood that in some embodiments only one steering lever may be coupled to the steering column with a corresponding cable. Accordingly, the other steering lever is referred to as just a “lever” for power transfer to the rear wheel, for example.

To further illustrate the example with two (2) steering levers, if the plane of the frame is defined by the XZ axes, the steering levers may be movable along a plane defined by the XY axes (e.g., substantially orthogonal to a plane formed by the frame). For instance, the steering levers may be able to deflect (or rotate) around the Z axis. However, while the plane of movement of the steering levers in this example is normal to the Z-axis, in other embodiments the plane of movement of the steering levers may not be normal to the Z-axis (e.g., if the steering levers are configured at an angle to the X or Y axes). Additionally, in some embodiments, the right and left steering levers may deflect together relative to the frame to correspondingly deflect the wheel relative to the frame. For example, in one embodiment described in more detail below, movement of each steering lever independently moves the steering column in opposite directions. Accordingly, when one steering lever is moved in either direction, the other steering lever is moved in the opposite direction. This may advantageously improve stability of the steering mechanism by providing left and right cross feedback to the user's hands to create an experience similar to having two hands on a pair of handlebars, for example, for improved balance and/or control.

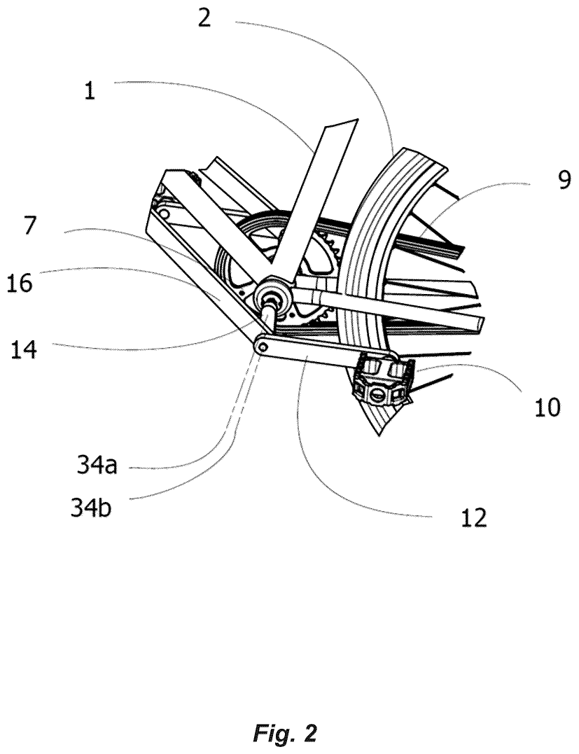

FIG. 2 illustrates coupling power from an arm to a crank post according to an embodiment. This example shows a portion of frame 1 comprising an upward post coupled to a seat 4, steering column 31, and rear wheel 2 (as shown in FIG. 1). FIG. 2 illustrates how arm member 16 and pedal 10 are coupled to crank post 14 and crank sprocket 7. Crank sprocket 7 rotates around a sprocket axis 34a offset from the pedal arm axis 34b. Crank post 14 comprises a proximate end coupled to a crank shaft on the sprocket axis 34a and a distal end coupled to arm member 16 and a pedal arm 12 on pedal arm axis 34b, which in turn is coupled to pedal 10. A substantially similar structure is also included on the opposite side of the frame. However, crank post 14 on one side is 180 degrees to crank post 15 on the opposite side. Additionally, crank post 14 may be shorter in length than pedal arm 12 to improve the power transfer from the arms and legs to the crank shaft, for example. Accordingly, as arms transfer power to arm member 16 and legs transfer power to pedal 10, crank post 14 rotates the crank shaft, which rotates the crank sprocket 7. Crank sprocket 7 may be coupled to a rear wheel sprocket 8 (shown in FIG. 1) by a chain 9, for example, to turn rear wheel 2 in response to power from the arms and legs of a user.

In some embodiments, the left and right arms are releasably coupled to the left and right crank posts, and movement of the pedals does not cause movement of the first and second steering levers. For example, it may be desirable for a rider to continue to pedal the bicycle while having the steering levers remain at a constant position (e.g., so the rider can focus on steering). In some embodiments, the left and right arms (e.g., arm member 16) may be releasably coupled to the crank shaft so that the pedals may move the crank shaft without requiring movement of the mechanical arms. A variety of mechanisms may be used for releasably connected the arm to the crank shaft (e.g., a releasable clutch or a one way ratchet). Such a technique may be beneficial for safety reasons so riders have the option of focusing on steering (e.g., at high speeds) while the steering levers remain stationary, for example.

FIG. 3 illustrates an example steering and arm mechanism according to an embodiment. This example illustrates various innovative aspects that are used together. However, other embodiments may include only one or the following features (or none). According to one such aspect, steering levers are coupled to the steering column by cables to move the front wheel. Various embodiments may use different types of cables to couple movement of the steering levers to movement of the steering column. For example, in one embodiment the cables may be wire cables. In another embodiment, the cables may be hydraulic cables (also commonly referred to as conduits). In yet another embodiment, the cables may be flexible rods which, when rotated, couple the rotation to the steering column. Accordingly, the following is just one illustrative example. FIG. 3 illustrates a front portion of frame 1. Steering lever 25 is coupled to two (2) wire cables 30a and 30b between the first steering lever and the steering column. The other steering lever may be similarly coupled to two wire cables coupled between the other steering lever and the steering column. Each steering lever and at least one cable are an example means for steering. For each pair of cables, one cable rotates the steering column in a first direction and the other cable rotates the steering column in a second direction. Yet another advantageous aspect of the present example are pulleys coupled to each steering lever. For example, pulley 23 is coupled to steering lever 25 and cables 30a-b are a single cable configured around pulley 23. Accordingly, as the steering levers are deflected from side to side, the pulley rotates, which causes the cables to turn steering column 31. In embodiments, cables 29a-b from the left steering lever and cables 30a-b from the right steering lever are tightly coupled to respective pulleys and steering column 31 to provide stabilizing cross feedback between the left and right steering levers and improve stability and control, for example. In this example, steering lever 25 is further coupled to a pulley support and cable sheath member 21. Member 21 comprises a base 21a adjacent to the pulley with cable holes to receive the cable(s) on a first side. The cable holes are sized to allow the cables to pass through, but small enough to act as a cable sheath support on the side opposite the pulley, for example. Member 21 may comprise an elevated piece 21b to allow attachment of the steering lever 25 and pulley 23 a height above base 21a. Here, pulley 23 and steering lever 25 may be rotationally coupled to the elevated piece 21b, for example, so that the pulley is fixed to the steering lever and the combined elements may deflect left and right relative to member 21 to move the cables, the steering column, and the front wheel. Similarly, steering column 31 is coupled to cable sheath support member 26, which may be mounted to frame 1, for example, to fix the cable sheaths (e.g., sheaths 27-28) and allow the cables therein to move.

FIG. 3 illustrates yet another of the above mentioned innovative aspects. In this example, frame 1 comprises frame crank posts 32 and 33 (FIG. 1) configured on opposite sides of the frame and extending above and below a plane of the frame. For instance, as highlighted in FIG. 3, frame crank post 33 provides a spatial offset for pivot point 40 from frame 1. The mechanical arms are rotationally coupled to the frame crank posts 32 and 33 so that the arm rotates around the pivot point 40 as the user moves the steering levers forward and back in the direction of travel, for example. As mentioned above, in this example embodiment, the mechanical arms comprise multiple arm members (e.g., lever to post arm member 19 and post to crank arm member 17). Here, arm member 19 is rotationally coupled to frame crank post 33 and arm member 17 is rotationally coupled to arm member 19. A substantially similar arrangement may be used for the other arm members on the other side of the frame (not shown in FIG. 3). As another more specific aspect of this example embodiment, a portion of arm member 19 at pivot point 40 is offset from the portion of arm member 19 at the linkage to arm member 17. For example, arm member 19 may be curved or angled. Accordingly, a portion of arm member 19 may form lever, which is actuated by the forward and backward movement of the steering levers. Movement of the lever portion of arm member 19, in turn, actuates arm member 17.

In some embodiments, a length from the center of the pulley to the edge of the pulley may be the same as length from the center of the barrel/axel of the steering column to the edge of the barrel of the steering column. These two lengths being the same may advantageously make the front wheel turns on a 1 to 1 ratio with the movement of the steering levers, for example.

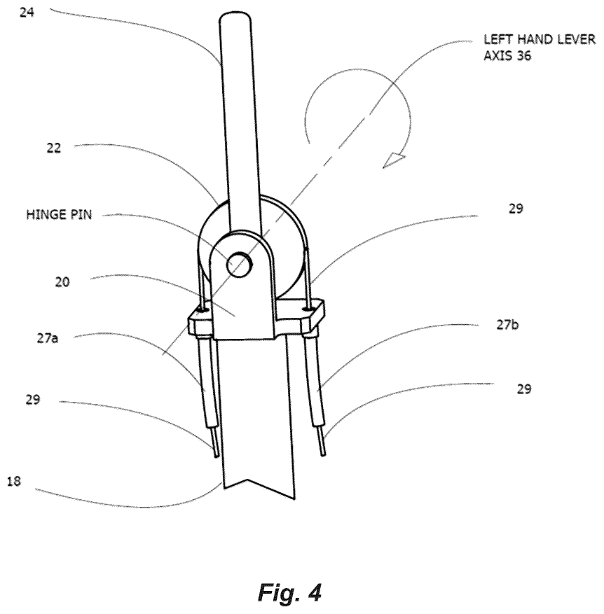

FIG. 4 illustrates an example steering mechanism according to an embodiment. This example illustrates a number of innovative aspects of one or more embodiments. For example, steering lever 24 may be deflected either right or left around an axis 36. Lever 34 is coupled to pulley 22 and support member 20. Pulley 22 and lever 24 are configured to rotate together to adjust cable 29, while support member 20 remains fixed to arm member 18. Pulley 22, lever 24, and support member 20 may be coupled together using a hinge pin, for example. Cable 29 and sheaths 27a-b are as described above.

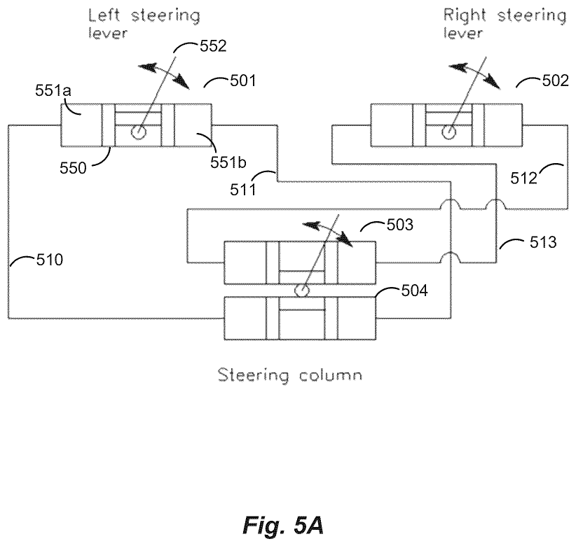

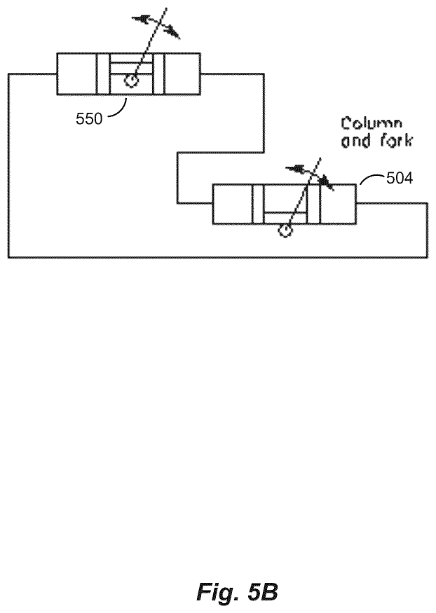

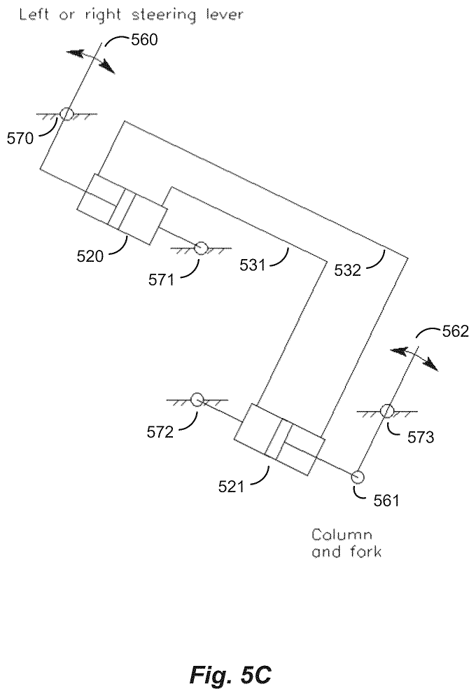

FIG. 5A illustrates another example steering mechanism according to an embodiment. This example illustrates the use of hydraulic cables. In this example a first hydraulic actuator 501 is coupled to a first steering lever, a second hydraulic actuator 502 is coupled to a second steering lever, and hydraulic actuators 503 and 504 are coupled to the steering column. Each hydraulic actuator comprises at least one movable piston 550, a pair of fluid chambers 551a-b, and an external position control member 552 to move the piston. Accordingly, as levers are moved from left to right, fluid is moved between chambers through hydraulic cables 510-513 to adjust the position of the steering column. Movement of the steering levers and steering column in response to movement of the pistons may be through rack and pinion rotary motion of a gear from hydraulic movement, or example, or lateral movement a lever in response to lateral movement of the piston. As mentioned above, some embodiments may have a steering lever and cable on one side of the frame. FIG. 5B illustrates a hydraulic system for single handed steering according to an embodiment. It is to be understood that wire cables or a flexible rod may be used for single sided steering in other embodiments.

FIG. 5C illustrates another example steering mechanism according to an embodiment. FIG. 5C illustrates two independent aspects of the present disclosure. First, FIG. 5C illustrates a single steering lever. Further, FIG. 5C illustrates a hydraulic system based on linear displacement of the piston to transfer movement from a steering lever to the steering column. In this example, the right or left steering lever 560 may be rotated around a pivot point 570, which moves a hydraulic cylinder in hydraulic actuator 520. Hydraulic actuator 520 may be coupled to a fixed point 571, for example. Fluid from hydraulic actuator 520 is coupled with hydraulic actuator 521 through hydraulic lines 531 and 532. Hydraulic actuator 521 is coupled to a fixed point 572 and one end of a lever 562 at 561. Lever 562 is coupled to a fixed pivot point 573, which may be coupled to the steering column. Accordingly, as lever 560 rotates, lever 562 causes the rotation of the steering column and the front wheel.

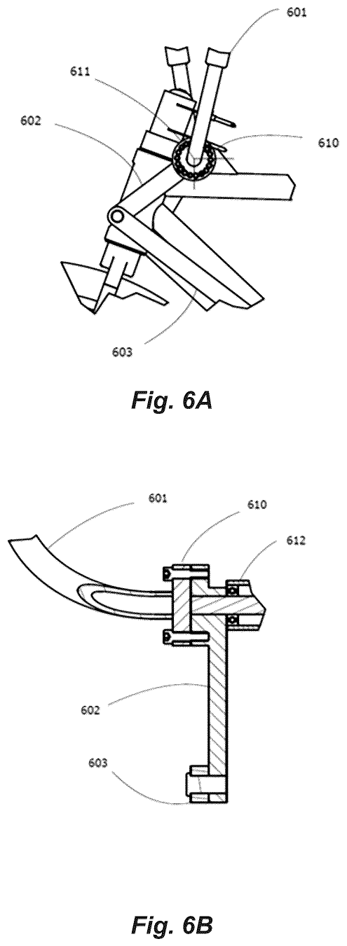

FIGS. 6A-B illustrates two views of another example of a mechanical arm according to an embodiment. As mentioned above, the angle of the steering levers may be adjustable. In this example, the arms between the steering levers and cranks comprise three (3) components. A first arm member 601 is coupled between a steering lever and an adjustment mechanism 610. A second arm member 602 is coupled between the adjustment mechanism 610 and the third arm member 603 through the pivot point 611, and the third arm member 603 is coupled between the second arm member 603 and the cranks (not shown). In this example, first arm member 601 is rotatably coupled to the adjustment mechanism 610 at a frame crank post 612 and the pivot point 611 in one of a plurality of fixed positions (e.g., engaging with one or more of a plurality of holes arranged around the periphery of a circular member to change the angle of the first arm member 601).

### Further Examples

Each of the following non-limiting features in the following examples may stand on its own or may be combined in various permutations or combinations with one or more of the other features in the examples below. In various embodiments, the present disclosure may be implemented as an apparatus, system, or as one or more of the innovative component parts.

In one embodiment, the present disclosure includes an apparatus comprising: a frame coupled to a first wheel and at least a second wheel, the first wheel configured to steer said apparatus; a first steering lever configured on a first side of the frame; a second steering lever configured on a second side of the frame; a first arm coupled between the first steering lever and a first crank post through a first pivot point on the first side of the frame; a second arm coupled between the second steering lever and a second crank post through a second pivot point on a second side of the frame; a first pedal arm coupled to the first crank post on the first side of the frame; a second pedal arm coupled to the second crank post on the second side of the frame; a steering column movably coupled to the frame and rigidly coupled to the first wheel; at least a first cable coupled between the first steering lever and the steering column; and at least a second cable coupled between the second steering lever and the steering column, wherein the first steering lever and the second steering lever are configured to move in a first plane not parallel to the frame and a second plane parallel to the frame, and wherein movement of the first and second steering levers in the first plane rotates the steering column and the first wheel, and wherein movement of the first and second steering levers in the second plane moves the first and second crank posts.

In one embodiment, the first and second steering levers deflect together relative to the frame to correspondingly deflect the first wheel relative to the frame.

In one embodiment, movement of the first and second steering levers in the first plane is substantially orthogonal to a plane formed by the frame.

In one embodiment, movement of the first and second steering levers to rotate the steering column is independent of movement of the first and second steering levers to move the first and second crank posts.

In one embodiment, a first force on the first steering lever in a direction parallel to the frame and a second force on the second steering lever in a direction parallel to the frame are decoupled from the movement of the first and second steering levers to rotate the steering column and the first wheel without the influence of the first force and the second force.

In one embodiment, the first and second crank posts are coupled to a crank sprocket, and wherein the crank sprocket is coupled to at least the second wheel.

In one embodiment, the crank sprocket is coupled to a third wheel.

In one embodiment, the first cable and the second cable are wire cables.

In one embodiment, the first cable and the second cable are hydraulic cables.

In one embodiment, the first cable and the second cable are flexible rods.

In one embodiment, the apparatus further comprises a third cable coupled between the first steering lever and the steering column; and a fourth cable coupled between the second steering lever and the steering column, wherein the first cable rotates the steering column in a first direction, the second cable rotates the steering column in a second direction, wherein the third cable rotates the steering column in the first direction, the fourth cable rotates the steering column in the second direction.

In one embodiment, the apparatus further comprises a first pulley and a second pulley, wherein the first cable and the third cable are a first single cable configured around the pulley, and wherein the second cable and the fourth cable are a second single cable configured around the pulley.

In one embodiment, the first arm comprises a first arm member and a second arm member, wherein the second arm comprises a third arm member and a fourth arm member, wherein one of the first arm member or the second arm member is coupled to the first side of the frame and the other one of the first arm member or the second arm member is coupled to the first crank post, and wherein one of the third arm member or the fourth arm member is coupled to the second side of the frame and the other one of the third arm member or the fourth arm member is coupled to the second crank post.

In one embodiment, the frame further comprises a first frame crank post forming the first pivot point and a second frame crank post forming the second pivot point, wherein the first frame crank post is configured opposite the second frame crank post on the frame, wherein the first arm is rotationally coupled to the first frame crank post and the second arm is rotationally coupled to the second frame crank post.

In one embodiment, the first arm member is coupled to the first frame crank post and the second arm member is rotationally coupled to the first arm member, and wherein the third arm member is coupled to the second frame rotationally post and the fourth arm member is rotationally coupled to the third arm member.

In one embodiment, the first arm is releasably coupled to the first crank post and the second arm is releasably coupled to the second crank post, and wherein the movement of the pedal arms does not cause movement of the first and second steering levers.

In one embodiment, angles of the first and second steering levers are adjustable.

In one embodiment, said apparatus is a bicycle.

In another embodiment, the present disclosure includes an apparatus comprising: a frame coupled to a first wheel and at least a second wheel, the first wheel configured to steer said apparatus; a first steering lever; a second lever; a first arm coupled between the first steering lever and a first crank post through a first pivot point on the first side of the frame; a second arm coupled between the second lever and a second crank post through a second pivot point on a second side of the frame; a first pedal arm coupled to the first crank post on the first side of the frame; a second pedal arm coupled to the second crank post on the second side of the frame; a steering column movably coupled to the frame and rigidly coupled to the first wheel; and at least a first cable coupled between the first steering lever and the steering column, wherein the first steering lever is configured to move in a first plane not parallel to the frame, wherein the first steering lever and the second lever are configured to move in a second plane parallel to the frame, and wherein movement of the first steering lever in the first plane rotates the steering column and the first wheel, and wherein movement of the first and second steering levers in the second plane moves the first and second crank posts.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. An apparatus comprising:
a frame coupled to a first wheel and at least a second wheel, the first wheel configured to steer said apparatus;
a first steering lever configured on a first side of the frame;
a second steering lever configured on a second side of the frame;
a first arm coupled between the first steering lever and a first crank post through a first pivot point on the first side of the frame;
a second arm coupled between the second steering lever and a second crank post through a second pivot point on a second side of the frame;
a first pedal arm coupled to the first crank post on the first side of the frame;
a second pedal arm coupled to the second crank post on the second side of the frame;
a steering column movably coupled to the frame and rigidly coupled to the first wheel;
at least a first cable coupled between the first steering lever and the steering column; and
at least a second cable coupled between the second steering lever and the steering column,
wherein the first steering lever and the second steering lever are configured to move in a first plane not parallel to the frame and a second plane parallel to the frame, and wherein movement of the first and second steering levers in the first plane rotates the steering column and the first wheel, and wherein movement of the first and second steering levers in the second plane moves the first and second crank posts.

2. The apparatus of claim 1, wherein the first and second steering levers deflect together relative to the frame to correspondingly deflect the first wheel relative to the frame.

3. The apparatus of claim 1, wherein movement of the first and second steering levers in the first plane is substantially orthogonal to a plane formed by the frame.

4. The apparatus of claim 1, wherein movement of the first and second steering levers to rotate the steering column is independent of movement of the first and second steering levers to move the first and second crank posts.

5. The apparatus of claim 1, wherein a first force on the first steering lever in a direction parallel to the frame and a second force on the second steering lever in a direction parallel to the frame are decoupled from the movement of the first and second steering levers to rotate the steering column and the first wheel without the influence of the first force and the second force.

6. The apparatus of claim 1, wherein the first and second crank posts are coupled to a crank sprocket, and wherein the crank sprocket is coupled to at least the second wheel.

7. The apparatus of claim 6, the crank sprocket is coupled to a third wheel.

8. The apparatus of claim 1, wherein the first cable and the second cable are wire cables.

9. The apparatus of claim 1, wherein the first cable and the second cable are hydraulic cables.

10. The apparatus of claim 1, wherein the first cable and the second cable are flexible rods.

11. The apparatus of claim 1, further comprising:
a third cable coupled between the first steering lever and the steering column; and
a fourth cable coupled between the second steering lever and the steering column,
wherein the first cable rotates the steering column in a first direction, the second cable rotates the steering column in a second direction, wherein the third cable rotates the steering column in the first direction, the fourth cable rotates the steering column in the second direction.

12. The apparatus of claim 11, further comprising a first pulley and a second pulley, wherein the first cable and the third cable are a first single cable configured around the pulley, and wherein the second cable and the fourth cable are a second single cable configured around the pulley.

13. The apparatus of claim 1, wherein the first arm comprises a first arm member and a second arm member, wherein the second arm comprises a third arm member and a fourth arm member, wherein one of the first arm member or the second arm member is coupled to the first side of the frame and the other one of the first arm member or the second arm member is coupled to the first crank post, and wherein one of the third arm member or the fourth arm member is coupled to the second side of the frame and the other one of the third arm member or the fourth arm member is coupled to the second crank post.

14. The apparatus of claim 13, the frame further comprising a first frame crank post forming the first pivot point and a second frame crank post forming the second pivot point, wherein the first frame crank post is configured opposite the second frame crank post on the frame, wherein the first arm is rotationally coupled to the first frame crank post and the second arm is rotationally coupled to the second frame crank post.

15. The apparatus of claim 14, wherein the first arm member is coupled to the first frame crank post and the second arm member is rotationally coupled to the first arm member, and wherein the third arm member is coupled to the second frame rotationally post and the fourth arm member is rotationally coupled to the third arm member.

16. The apparatus of claim 1, wherein the first arm is releasably coupled to the first crank post and the second arm is releasably coupled to the second crank post, and wherein the movement of the pedal arms does not cause movement of the first and second steering levers.

17. The apparatus of claim 1, wherein angles of the first and second steering levers are adjustable.

18. The apparatus of claim 1, wherein said apparatus is a bicycle.

19. An apparatus comprising:
a frame coupled to a first wheel and at least a second wheel, the first wheel configured to steer said apparatus;
first means for steering configured on a first side of the frame;
second means for steering configured on a second side of the frame;
first means for arm power transfer coupled between the first steering lever and a first crank post through a first pivot point on the first side of the frame;
second means for arm power transfer coupled between the first steering lever and a second crank post through a second pivot point on a second side of the frame;
a first pedal arm coupled to the first crank post on the first side of the frame;
a second pedal arm coupled to the second crank post on the second side of the frame;
means for moving the first wheel relative to the frame;
at least one first means for coupling movement of the first means for steering to the means for moving the first wheel; and
at least one second means for coupling movement of the second means for steering to the means for moving the first wheel,
wherein the first steering means and the second steering means move in a first plane and a second plane, and wherein movement of the first steering means and the second steering means in the first plane rotates the first wheel, and wherein movement of the first steering means and the second steering means in the second plane moves the first and second crank posts.

1. An apparatus comprising:
a frame coupled to a first wheel and at least a second wheel, the first wheel configured to steer said apparatus;
a first steering lever;
a second lever;
a first arm coupled between the first steering lever and a first crank post through a first pivot point on the first side of the frame;
a second arm coupled between the second lever and a second crank post through a second pivot point on a second side of the frame;
a first pedal arm coupled to the first crank post on the first side of the frame;
a second pedal arm coupled to the second crank post on the second side of the frame;
a steering column movably coupled to the frame and rigidly coupled to the first wheel; and
at least a first cable coupled between the first steering lever and the steering column,
wherein the first steering lever is configured to move in a first plane not parallel to the frame, wherein the first steering lever and the second lever are configured to move in a second plane parallel to the frame, and wherein movement of the first steering lever in the first plane rotates the steering column and the first wheel, and wherein movement of the first and second steering levers in the second plane moves the first and second crank posts.
